(19) United States
(12) Patent Application Publication
(10) Pub. No.: US 2013/0275552 A1
(43) Pub. Date: Oct. 17, 2013

(54) VIRTUAL DESKTOP SYSTEM

(71) Applicant: CISCO TECHNOLOGY, INC., San Jose, CA (US)

(72) Inventors: Subha Dhesikan, San Jose, CA (US); Ken Morneault, Watkinsville, GA (US)

(73) Assignee: Cisco Technology, Inc., San Jose, CA (US)

(21) Appl. No.: 13/676,622

(22) Filed: Nov. 14, 2012

Related U.S. Application Data
(60) Provisional application No. 61/624,503, filed on Apr. 16, 2012.

(51) Int. Cl. G06F 15/173

(52) U.S. Cl. 709/217; 709/224

(57) ABSTRACT

A virtual desktop system may include a network device operable to receive data traffic from one or more terminal devices or data centers, via one or more communication channels. The network device may be operable to: monitor the data traffic for end-point information communicated from the one or more terminal devices or data centers; and identify, in the data traffic, the end-point information. The network device may also be operable to: determine one or more network services to operate or forward based on an aspect of the end-point information; and operate or forward the one or more network services, accordingly.

### PRIORITY CLAIM

This application claims the benefit of priority from Provisional Patent Application No. 61/624,503, filed Apr. 16, 2012, which is incorporated by reference.

### FIELD

The present disclosure relates to virtual desktop systems.

### BACKGROUND

An operating system on a centralized or remote server can host a virtual desktop system. Such a system may provide a desktop environment (including one or more remote operating systems and applications) to a client device. A virtual desktop system (also commonly referred to as a virtual desktop infrastructure) may include one or more protocols for providing a desktop environment to a client or another type of network device. Such protocols can limit the visibility and granularity of network operations of a virtual system.

### BRIEF DESCRIPTION OF THE DRAWINGS

FIG. 1 illustrates a block diagram of an example virtual network architecture that can include an example terminal device and data center, which can implement at least an aspect of an example virtual desktop system;

FIG. 2 illustrates a block diagram of an example network that can implement the virtual network architecture of FIG. 1 and include example terminal devices and an example data center, which can implement at least an aspect of an example virtual desktop system;

FIG. 3 illustrates a block diagram of an example centralized or terminal device that can implement at least an aspect of an example virtual desktop system, such as the virtual desktop system in FIG. 1 or 2;

FIG. 4 illustrates a block diagram of example network device that can implement at least an aspect of an example virtual desktop system, such as the virtual desktop system in FIG. 1 or 2; and

FIG. 5 illustrates a flow chart of an example method performed by one or more of the network devices of FIG. 1 or 2.

FIG. 6 illustrates a flow chart of an example method performed by at least one of the terminal devices of FIG. 1 or 2.

### DESCRIPTION OF EXAMPLE EMBODIMENTS

### Overview

In one aspect of a virtual desktop system, at least one network device of a network is operable to receive data traffic from one or more terminal devices or data centers, via one or more communication channels. The network device is further operable to: monitor the data traffic for end-point information communicated from the one or more terminal devices or data centers; identify, in the data traffic, the end-point information; and associate the end-point information with the network, so that the network is operable to deliver one or more network services. The network device may also be operable to: determine one or more network services to operate or forward based on an aspect of the end-point information; and operate or forward the one or more determined network services based on the aspect of the end-point information. The one or more network services may include one or more of quality of service (QoS), connection admission control (CAC), monitoring services, identification services, policy management services, performance routing, or location services.

The end-point information may include identification information associated with one or more applications executed on the one or more terminal devices or data centers. The identification information may be generated by one or more virtual network architecture (VNA) clients integrated with the one or more applications. Also, the identification information may link the one or more applications to the network device.

The one or more VNA clients may link the one or more applications to the network device via the identification information by associating the one or more applications with the network device. Also, the one or more VNA clients may be hosted on the one or more terminal devices or data centers.

In another aspect of a virtual desktop system, an electrical device (such as a terminal device, centralizing device, or a data center) may be operable to: generate identification information that includes information associated with one or more applications executed on the electrical device; and transmit the identification information to one or more network devices via one or more communication channels to identify, at the one or more network devices, one or more data streams or packets associated with the one or more applications. The electrical device may also be operable to: transmit the one or more data streams or packets to the one or more network devices; and receive network services from the one or more network devices, wherein the network services are based on the identification information.

Also, the electrical device may include one or more VNA clients, and the one or more VNA clients may provide the generation of the identification information, delayed or in real time. Further, the identification information may include application session information that may include session identification information.

The identification information may link the one or more applications to the one or more network devices. Also, the session identification information may link one or more application sessions of the one or more applications to the one or more network devices.

In another aspect of a virtual desktop system, a network device of a network may include a receiver operable to receive data traffic from one or more terminal devices or data centers, via one or more communication channels. Further, the network device may include a memory that includes processor executable instructions operable to: monitor the data traffic for end-point information communicated from the one or more terminal devices or data centers; identify, in the data traffic, the end-point information; determine one or more network services to operate or forward based on an aspect of the end-point information; associate the end-point information with the network, so that the network is operable to deliver the one or more network services; and operate or forward the one or more network services based on the aspect of the end-point information. Also, the network device may include a transceiver operable to transmit one or more of the one or more network services or the data traffic.

### Example Embodiments

Various embodiments described herein can be used alone or in combination with one another. The foregoing detailed description will describe only a few of the many possible implementations of the present embodiments. For this reason, this detailed description is intended by way of illustration, and not by way of limitation.

A virtual desktop system (VDS) or a virtual desktop infrastructure (VDI) may include several types of devices, including network devices, terminal devices, and centralized devices, such as a server. One or more centralized or remote servers may host software aspects of a VDS. Such software may facilitate the generation, operation, and communication of a desktop environment to terminal devices via one or more protocols and/or services, such as VDI protocols. Through such protocols and/or services, a desktop environment may be provided to terminal devices. Network devices may be operable to provide network services based on applications provided through the desktop environment.

With respect to VDI protocols, such protocols may introduce issues for network devices (such as routers, switches, hubs, and gateways) that route, monitor, and control data traffic on a network. The issues can include loss of visibility and loss of granularity. Data traffic communicated via a VDI protocol may use any type of protocol, such as a proprietary protocol. In one example, the data may be encrypted and compressed, such as by one or more proprietary methods. Thus, a network device may not recognize the data traffic; and therefore, identification of an application to which a particular packet or stream belongs may be difficult. In such a case, provision of an appropriate service for the data traffic may be compromised, due to the difficulty in identifying the application associated with the traffic. For example, network services, such as quality of service/connection admission control (QoS/CAC), application flow monitoring, identity services, policy services, performance routing (PfR), or location services, may be underutilized. For example, with respect to QoS, application of a differentiated services code point (DSCP) value to appropriate aspects of the data traffic may be less than optimal.

Also, network services may enable the data traffic to be divided into separate virtual local area networks (VLANs); however, such functionality can be limited when recognition of the traffic is difficult. Further, when data traffic is difficult to recognize, effective monitoring for degradation can be compromised.

Furthermore, the data traffic may include data associated with multiple applications. In such a case, where the data traffic may include data associated with multiple applications, a network device may not distinguish between applications and thus provision of an appropriate service could be adversely effected.

One solution to these issues is to utilize known ports for communicating the data traffic. Such a solution may be useful; however, it has limitations and issues. For example, in some infrastructures predefined ports may be replaced by network administrators, making it more difficult for network devices to recognize particulars of the data traffic.

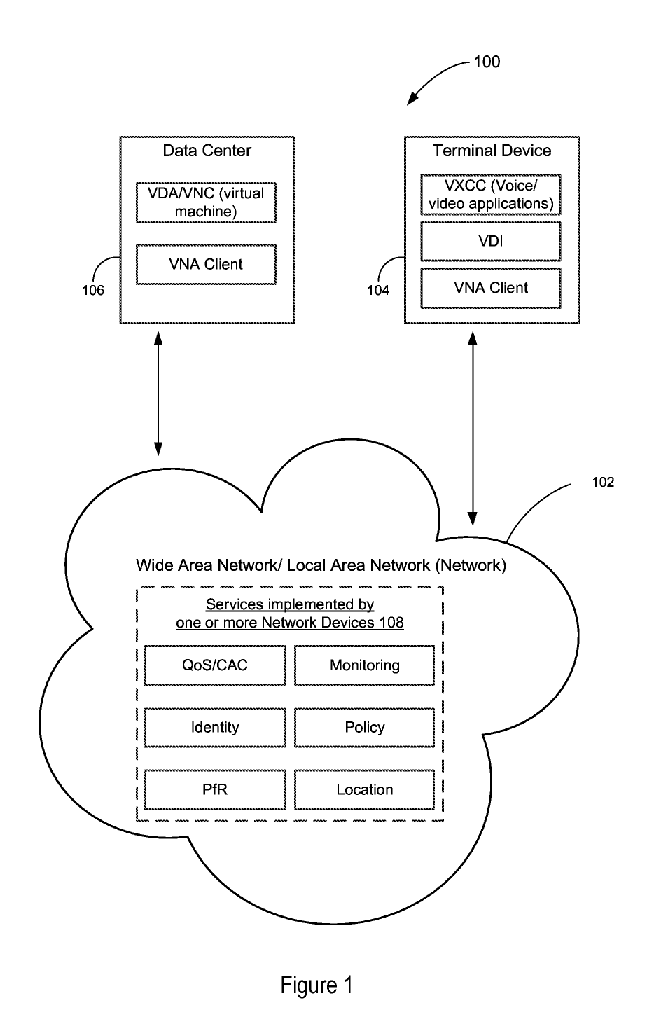

Another solution, a VNA (such as the example VNA 100 depicted in FIG. 1), may resolve these issues by providing mechanisms to make the network more aware of contents of the data traffic. The VNA may provide network visibility to virtual desktops and applications. The VNA may allow for linking of one or more network devices to one or more applications via information, such as data links. Further, the VNA enables dynamic configuration of network services for virtual desktop environments. Also, the VNA can provide a software defined network (SDN) for a VDS, such as an SDN for a Virtualization Experience Infrastructure (VXI).

The VNA may include one or more VNA clients. The VNA client(s) may be stored and/or executed at one or more terminal devices and at one or more data centers, such as a terminal device 104 and a data center 106 of FIG. 1. In some examples, the one or more data centers may include a respective centralizing device and database whereas in other examples decentralized devices and databases may be used. The one or more VNA clients may, for example, be integrated with one or more respective VDI clients, such as respective VDI clients of the terminal device 104 and the virtual machine of the data center 106. In some examples, one or more VNA clients at one or more data centers may create respective links with one or more networks and one or more respective network devices. For example, in one aspect of the VNA, one or more VNA client agents may be integrated in remote applications transmitting data traffic into a respective network, such as a local area network (LAN)/wide area network (WAN) 102 of FIG. 1. To support a VNA, the data traffic may include end-point information such as one or more of metadata, identity information (such as device identifiers, session identifiers, and/or application identifiers), flow tuple, and the like. The data traffic may be communicated via one or more network communications standards, such as Cisco Discovery Protocol (CDP), Linked Layer Discovery Protocol (LLDP), IEEE 802.1x, and Resource Reservation Protocol (RSVP), or any other communication standard.

The VNA may also include one or more communication channels between the one or more VNA clients of the one or more terminal devices and data centers (hereinafter the one or more VNA clients) and the one or more network devices. Through the VNA, the one or more communication channels may communicate communication specific parameters, such as one or more of the end-point information, source device types, protocol information, flow tuples, and the like.

The VNA may also include the one or more network devices (such as network device(s) 108), wherein the one or more devices may provide network services. In one example, the one or more network devices can leverage the end-point information received to determine which network services to apply. The one or more network devices may include switches, routers, standalone access points, identity service engines, collaboration managers, wireless control systems, authentication, authorization, and accounting (AAA) servers, network management servers, and the like.

To perform one or more of the network services, the one or more VNA clients may collect relevant information from respective VDI applications and may communicate the relevant information to the one or more network devices. The one or more network devices may be configurable to execute network services that use the relevant information. Further, the relevant information may be updated for the network services in real time by the VNA client. The relevant information may include virtual desktop information (such as terminal device to back-end virtual desktop linking information), metadata, and/or virtual remote endpoint identification information.

The relevant information may also include device information, protocol information, a 5-tuple used for displaying protocol traffic, a type of flow, user identification, a service level profile ranking or service level agreement (such as gold, silver or bronze), power data associated with a terminal device or network device, and/or location information associated with a terminal device, data center, or network device. For example, the device information may include platform identification, device type, and/or MAC address.

The protocol information may include information as to whether a protocol is from an independent computing architecture (ICA), a remote desktop protocol (RDP), personal computer over Internet protocol (PCoIP), and/or any other protocol useable in the VDI. The protocol information may also include additional data defined by such protocols. For example, the 5-tuple used for displaying protocol traffic may include one or more of a source address, a destination address, and port numbers.

The “type of flow” information would be used to describe data in the flow. Example types of data for “type of flow” include video, voice, email, print traffic, and signaling traffic data. In addition, the “type of flow” information may describe additional attributes about the flow. Examples of attributes include average and peak bit rate, bandwidth, and protocol version.

The user identification describes a user with information such as user name, user id, and user group. The service profile may include one or more quality of service requirements or priorities. Example service profile levels may include gold, silver, and bronze levels.

The power data associated with a terminal device or network device may include a power requirement or power consumption of the respective device. The power requirement may be defined by wattage to support a device or wattage to support a device and its peripherals (such as a camera, a printer, or any Universal Serial Bus (USB) connectable device). The power consumption may, for example, be defined by wattage currently consumed by a device.

The location information associated with a terminal device or network device may be determined based on a global positioning system (GPS). The one or more network devices may store and enforce several security levels based on location. For example, where a user is working from a public place, the user is less likely to have access to certain applications. A user, who is logging into a computer on a private network, may have access to such certain applications.

The network services may include QoS marking and/or policing based on identification of a data packet or stream, such as an audio and/or video media stream, and identification of an application sending the data packet or the data stream. Also, via a network device, the network services can enforce security policies and identify, label, and/or direct data traffic to a designated VLAN. Further, association of a client device and/or data center can be used for implementing other types of policies, such as improvements in security, energy efficiency, and visibility, for example.

Also, for example, visibility services may include providing a gateway function. However, such a function may burden network performance, because it may include, for example, manipulation of packets, including licensing, encryption, and compression operations. To lessen the amount of resources using network services, the VNA may, for example, utilize a handshake between a VDI application and a respective network.

Further, a network device can route data traffic using PfR. One aspect of the VNA may provide traffic information and metrics for PfR based on end-point information. Further, through network services, a network device may trace and monitor application flow, such as the flow of data traffic associated with an application through one or more network devices and/or terminal devices. For example, application degradation may be monitored. Also, admission control or bandwidth management can be provided once priority and the origination of the flow of data traffic for an application is known.

Furthermore, the VNA can provide location information, such as GPS information, to a network device or terminal device, and then network services can be adapted to the location information.

FIG. 1 illustrates a block diagram of an example VNA 100 that can include terminal devices (such as the terminal device 104) and data centers (such as the data center 106) that can implement aspects of an example VDS and VNA. The VNA 100 may also include at least one communication network, such as the LAN/WAN 102. In other examples, the communication network may be any other form of communication network. The terminal device 104 can, separately or in combination with another terminal device, implement an example aspect of the VNA, such as a VNA client, one or more voice/video applications (such as Virtualization Experience Client Controller (VXCC)), and VDI. Although not depicted, the VNA 100 may also include other terminal devices, one or more network devices (such as the network device(s) 108), mass storage, and other LANs or WANs or any other form of area network, such as a metropolitan area network (MAN) and/or a storage area network (SAN). Also, the data center 106 can, separately or in combination with another network or device, or terminal device, implement an example aspect of the VNA, such as a VNA client and virtual desktop access/virtual network computing (VDA/VNC) software. Further the LAN/WAN 102, may include the one or more network devices (such as the network device(s) 108) that may implement the network services, such as QoS/CAC, monitoring (such as application flow monitoring), identity (such as resource identification), policy adherence, PfR (such as Intelligent Routing), and location services.

The VNA 100 may couple network nodes so that communications between such nodes can occur, whether communications are wire-line or wireless communications. Such communications occur via wire-line or wireless channels, and in communicating across such channels, the VNA 100 may utilize various architectures and protocols and may operate with a larger system of networks. Further, the various nodes of the VNA 100 may provide configurations for differing architectures and protocols. For example, a router may provide a link between otherwise separate and independent LANs, and a network switch may connect two or more nodes or groups of nodes. Signaling formats or protocols employed may include, for example, TCP/IP, UDP, or the like. Furthermore, the VDI client may utilize protocols such as Remote Desktop Protocol (RDP), PCoIP, rdesktop, tsclient, KDE Remote Desktop Connection (KRDC), VirtualBox Remote Desktop Protocol (VRDP), and the like.

The VNA 100 may also include one or more computational nodes that include aspects of the VNA. The terminal device 104, the data center 106, and the network device(s) 108 may be computational nodes. A computational node may be one or more of any electronic device that can perform computations, such as a general-purpose computer, a mainframe computer, a workstation, a desktop computer, a laptop computer, a mobile device, and so forth. Also, a computational node can include logic, such as application logic and logic of the VNA. For example, a computational node can include logic to perform operations such as the method 500 or 600 (described below).

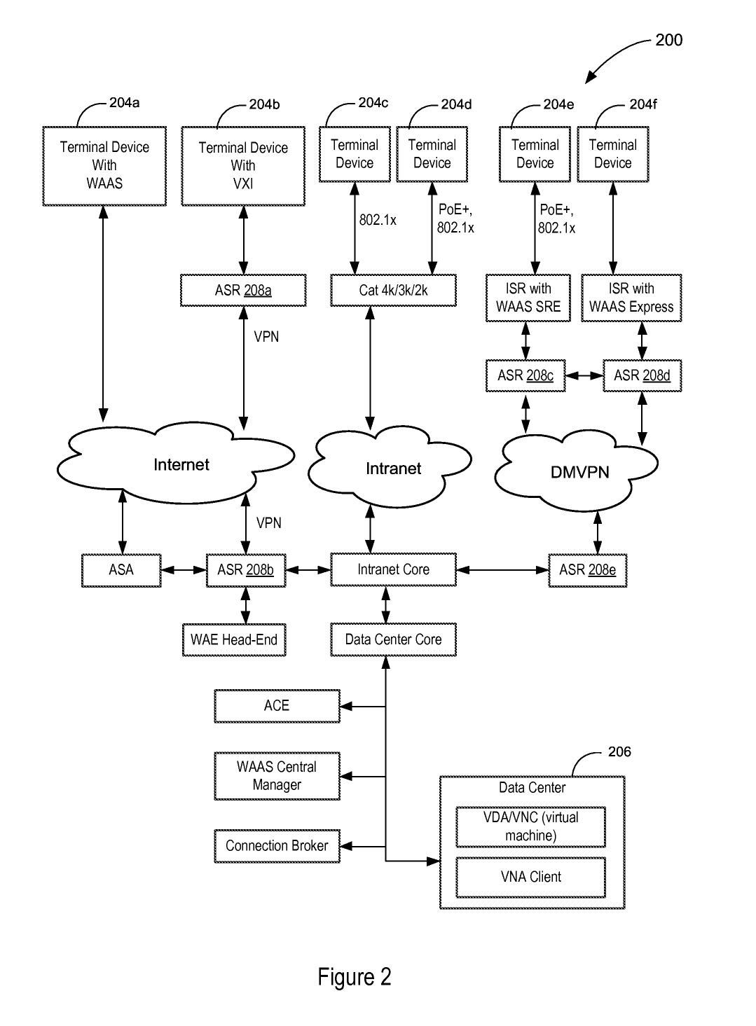

FIG. 2 illustrates a block diagram of an example network 200 that can implement the VNA of FIG. 1 and include example terminal devices (such as the terminal devices 104 and 204a-204f) and example data centers (such as the data center 106 and 206) that can implement aspects of an example VDS and VNA. In other examples, other configurations and functionality are possible, and the network depicted in FIG. 2 is simply one non-limiting example configuration. For example, besides a data center including a VNA client (as shown in FIG. 2), the terminal devices (such as the terminal devices 104 and 204a-204f) may include a VNA client, respectively.

In FIG. 2, the terminal device 204a utilizes the VNA via Wide Area Application Services (WAAS), the Internet, Adaptive Security Appliances (ASA), and an Aggregation Services Router (ASR) 208b. WAAS may optimize performance of applications, such as TCP-based applications, operating in a WAN while maintaining branch security. For example, WAAS may combine WAN optimization, optimization of the Transport Control Protocol (TCP), Data Redundancy Elimination (DRE) and application protocol acceleration in a single network-attached appliance or router-integrated module. ASA may provide secured communication, such as virtual private networking (VPN), firewall and network address translation (NAT) functions, and/or intrusion prevention systems (IPS). ASR may provide high performance data traffic routing.

The terminal device 204b in FIG. 2 may utilize the VNA via a communication platform such as VXI, the Internet, VPN, and ASRs 208a and 208b. VXI may provide an integration of virtual desktop computing, voice, and video services along with security services. Furthermore, in FIG. 2, terminal devices 204a and 204b may utilize a wide area application engine (such as WAE Head-End).

The terminal devices 204c and 204d of FIG. 2 may utilize the VNA via 802.1x, Power over Ethernet (PoE) (depicted for 204d), Continuous Asynchronous Transmission (CAT) 4k, 3k, and/or 2K, and/or an intranet.

Further, the terminal devices 204e and 204f in FIG. 2 may utilize the VNA via 802.1x, Power over Ethernet (PoE) (depicted for 2042), integrated services router (ISR) with WAAS Services Ready Engine (SRE) or Express, ASR 208C or 208D, dynamic multipoint VPN (DMVPN), and ASR 208e. DMVPN may provide for creating secure tunnels, such as a dynamic-mesh VPN network without having to pre-configure all possible tunnel end-point peers.

As depicted in FIG. 2, the terminal devices 204a-204f and a data center (such as data center 106 or 206) can utilize the VNA and interact via an intranet core, a data center core, Application Control Engine (ACE), a WAAS Central Manager (CM), and a remote desktop connection broker.

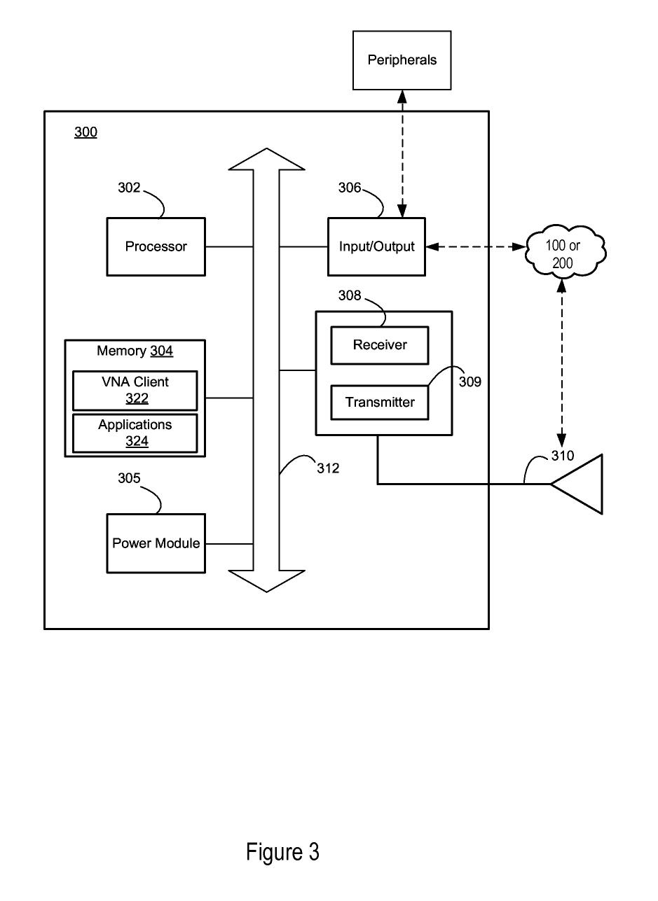

FIG. 3 illustrates a block diagram of example centralized or terminal device 300 that can implement an aspect of an example VDS or VNA. Instances of the centralized or terminal device 300 (hereinafter device 300) can be one of the terminal devices 104 or 204a-204f, or an aspect of the data center 106 or 206, or any other electronic device or set of electronic devices capable of at least storing and executing one or more aspects of the VNA and communicating with other nodes of a network, such as the VNA 100 or the network 200.

The device 300, which can be a combination of multiple electronic devices, may include a processor 302, memory 304, a power module 305, input/output 306 (including input/out signals and internal, peripheral, user, and network interfaces), a receiver 308 and a transmitter 309 (or a transceiver), an antenna 310 for wireless communications, and a communication bus 312 that connects the aforementioned elements of the device.

The processor 302 can be one or more of any type of processing device, such as a central processing unit (CPU). Also, for example, the processor 302 can be central processing logic; central processing logic includes hardware, firmware, software and/or combinations of each to perform a function(s) or an action(s), and/or to cause a function or action from another component. Also, based on a desired application or need, central processing logic may include a software controlled microprocessor, discrete logic such as an application specific integrated circuit (ASIC), a programmable/programmed logic device, memory device containing instructions, or the like, or combinational logic embodied in hardware. Also, logic may also be fully embodied as software.

The memory 304, such as RAM or ROM, can be enabled by one or more of any type of memory device, such as a primary (directly accessible by the CPU) and/or a secondary (indirectly accessible by the CPU) storage device (such as flash memory, magnetic disk, optical disk). Further, the memory 204 may include applications 324 and an example VNA client 322, such as one of the VNA clients mentioned above.

The power module 305 may contain one or more power components, and facilitates supply and management of power to the terminal device 300.

The term “module” may be defined to include a plurality of executable modules. As described herein, the modules are defined to include software, hardware or some combination thereof executable by a processor. Software modules may include instructions stored in memory that are executable by the processor. Hardware modules may include various devices, components, circuits, gates, circuit boards, and the like that are executable, directed, and/or controlled for performance by the processor. Furthermore, any aspect of the system or combination of aspects described herein may be a module.

The input/output 306, can include any interfaces for facilitating communication between any components of the device 300, components of external devices (such as components of other devices of the VNA 100 or the network 200), and end users. For example, such interfaces can include a network card that may be an integration of the receiver 308, the transmitter 309, and one or more I/O interfaces. The network card, for example, can facilitate wired or wireless communication with other nodes of the VNA 100 or the network 200. In cases of wireless communication, the antenna 310 can facilitate such communication. Also, the I/O interfaces, can include user interfaces such as monitors, keyboards, touchscreens, microphones, and speakers. Further, some of the I/O interfaces and the bus 312 can facilitate communication between components of the device 300, and in one embodiment ease processing performed by the processor 302.

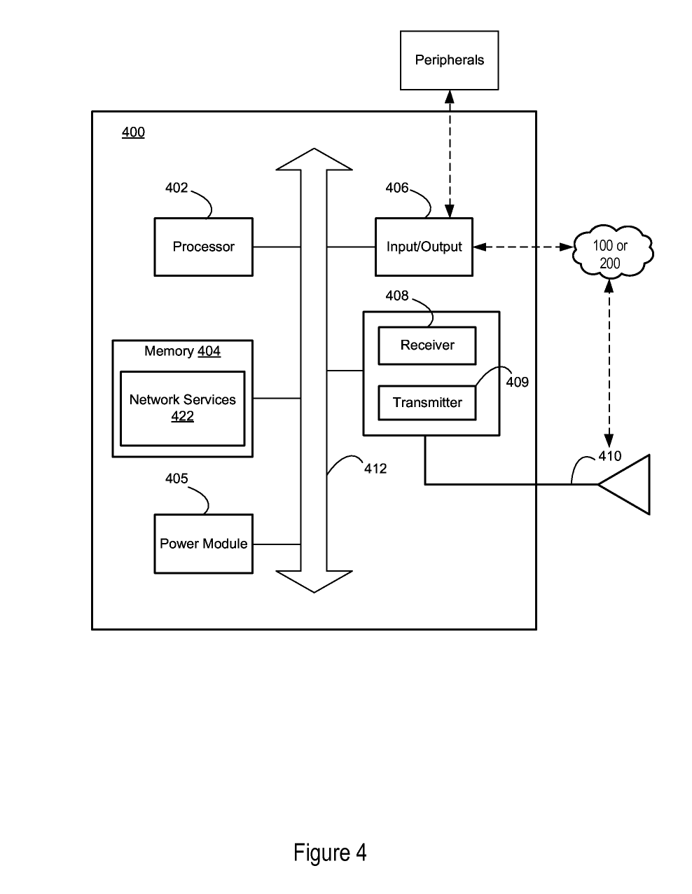

FIG. 4 illustrates a block diagram of example network device 400 that can implement an aspect of an example VDS or VNA. Instances of the network device 400 (hereinafter device 400) can be any one or more of the ASRs 208a-208e, Cat 4k, 3k, and/or 2k, ISRs, ASA, Intranet Core, Data Center Core, WAE Head-end, ACE, WAAS Central Manager, or connection broker of FIG. 2, or any other electronic device or set of electronic devices capable of at least storing and executing one or more aspects of the VNA that provide network services or administers, manages, or routes communications between nodes of a network, such as the VNA 100 or the network 200.

Similar to device 300, the device 400, which can be a combination of multiple electronic devices, may include a processor 402, memory 404, power module 405, input/output 406 (including input/out signals and internal, peripheral, user, and network interfaces), receiver 408 and transmitter 409 (or a transceiver), antenna 410 for wireless communications, and communication bus 412 that connects the aforementioned elements of the device.

The processor 402 may be similar to the processor 302. The memory 404 may be similar to the memory 304. Further, the memory 404 may include instructions that provide network services 422, such as the network services mentioned. Similarly, the power module 405 may contain one or more power components, and can facilitate supply and management of power to the device 400. Also, the input/output 406 may be similar to the input/output 306.

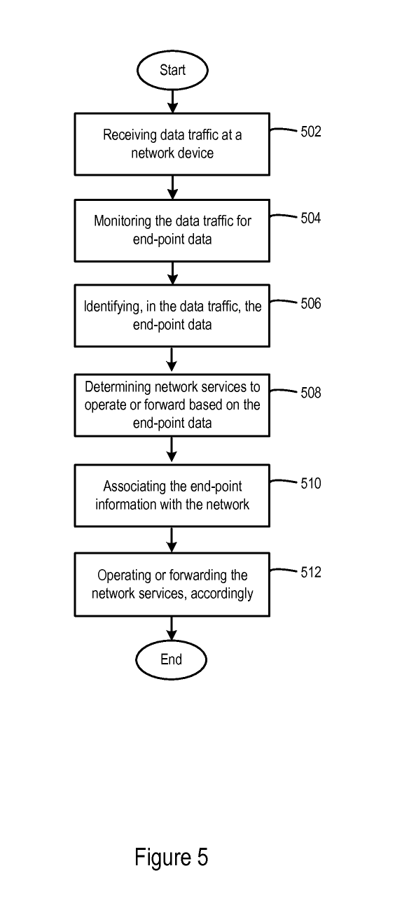

FIG. 5 illustrates a flow chart of an example method 500 performed by one or more of the network devices of FIGS. 1 and 2. In one embodiment, the processor 402 performs and/or controls the operations described by the method 500 by executing processing device readable instructions encoded in the memory 404, for example. Further, in one embodiment, the device readable instructions encoded in the memory 404 may include the network services 422.

The method 500 includes a receiver receiving data traffic at a network device of a network from one or more terminal devices or data centers, via one or more communication channels (at 502). At 504, device readable instructions, such as the instructions encoded in the memory 404, may be executed to perform monitoring of the data traffic for end-point information communicated from the one or more terminal devices or data centers, and at 506, identifying, in the data traffic, the end-point information. At 508, the device readable instructions may be executed to perform determining one or more network services that a network device can operate or forward to a terminal device or data center based on an aspect of the end-point information., At 510, the device readable instructions may associate the end-point information with the network, so that the network is operable to deliver one or more network services. At 512, the device readable instructions may operate or forward the one or more network services based on the aspect of the end-point information. For example, a network service may be forwarded via a transmitter of the network device, which can then transmit the service to another device.

The VNA, by providing application information to the network, may facilitate the one or more network devices to provide one or more network services. For example, monitoring and QoS may be provided by multiple networks devices, and Differentiated Services Code Point (DSCP) remarking may only be provided by a single network device. Also, such devices may operate on network traffic or a forward.

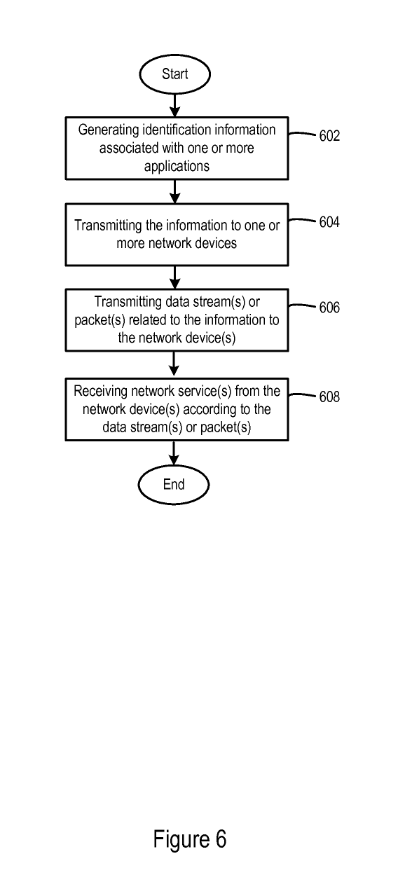

FIG. 6 illustrates a flow chart of an example method 600 that can be performed by one or more of the centralized or terminal devices of FIGS. 1 and 2. In one embodiment, the processor 302 performs and/or controls operations described by the method 600 by executing processing device readable instructions encoded in the memory 304, for example. Further, in one embodiment, the device readable instructions encoded in the memory 304 may include the VNA client 322 and one or more applications, such as applications 324 utilized through the VNA client 322.

The method 600 includes an electrical device, at 604, generating identification information that includes information associated with one or more applications executed on the electrical device. At 604, a transmitter of the electrical device transmits the identification information to one or more network devices via one or more communication channels to identify, at the one or more network devices, one or more data streams or packets associated with the one or more applications. At 606, the transmitter transmits the one or more data streams or packets to the one or more network devices. Based on the one or more network devices identifying the one or more data streams or packets and the one or more network devices determining and transmitting the one or more network services according to the identified one or more streams or packets, a receiver of the electrical device receives the one or more network services from the one or more network devices (at 608).

Various embodiments described herein can be used alone or in combination with one another. The foregoing detailed description has described only a few of the many possible implementations of the present embodiments. For this reason, this detailed description is intended by way of illustration, and not by way of limitation.

We claim:

1. A method comprising:
receiving data traffic at a network device of a network from one or more terminal devices or data centers, via one or more communication channels;
monitoring the data traffic for end-point information communicated from the one or more terminal devices or data centers;
identifying, in the data traffic, the end-point information; and
associating the end-point information with the network, so that the network is operable to deliver one or more network services.

2. The method of claim 1, comprising:
determining one or more network services to operate or forward based on an aspect of the end-point information; and
operating or forwarding the one or more determined network services based on the aspect of the end-point information.

3. The method of claim 1, wherein the end-point information includes identification information associated with one or more applications executed on the one or more terminal devices or data centers.

4. The method of claim 3, wherein the identification information is generated by one or more virtual network architecture (VNA) clients integrated with the one or more applications.

5. The method of claim 3, comprising: linking the one or more applications to the network device based on the identification information.

6. The method of claim 4, comprising linking the one or more applications to the network device by the identification information, via the one or more VNA clients.

7. The method of claim 4, wherein the one or more VNA clients are hosted on the one or more terminal devices or data centers.

8. The method of claim 2, wherein the one or more determined network services include one or more of quality of service (QoS), call admission control (CAC), monitoring services, identification services, policy management services, performance routing, or location services.

9. A method comprising:
generating at an electrical device, identification information that includes information associated with one or more applications executed on the electrical device; and
transmitting the identification information to one or more network devices via one or more communication channels to identify, at the one or more network devices, one or more data streams or packets associated with the one or more applications.

10. The method of claim 9, comprising: transmitting the one or more data streams or packets to the one or more network devices.

11. The method of claim 9, comprising: receiving network services from the one or more network devices, wherein the network services are based on the identification information.

12. The method of claim 9, wherein the electrical device is a terminal device.

13. The method of claim 9, wherein the electrical device is a centralized device or data center.

14. The method of claim 9, wherein the electrical device includes one or more virtual network architecture (VNA) clients, and wherein the method further comprises generating the identification information with one or more VNA clients.

15. The method of claim 9, wherein the generation of the identification information is in real time.

16. The method of claim 9, wherein the identification information includes session information that includes session identification information.

17. The method of claim 9, wherein the identification information includes session information that includes session identification information, and wherein the generation of the session information is in real-time.

18. The method of claim 9, wherein generating the identification information comprises linking the one or more applications to the one or more network devices using the identification information.

19. The method of claim 17, wherein the session identification information comprises linking one or more application sessions of the one or more applications to the one or more network devices using the session identification information.

20. A network device of a network comprising:
a receiver operable to receive data traffic from one or more terminal devices or data centers, via one or more communication channels;
a memory that includes processor executable instructions operable to:
monitor the data traffic for end-point information communicated from the one or more terminal devices or data centers;
identify, in the data traffic, the end-point information;
determine one or more network services to operate or forward based on an aspect of the end-point information;
associate the end-point information with the network, so that the network is operable to deliver the one or more network services; and
operate the one or more network services based on the aspect of the end-point information; and
a transceiver operable to transmit at least one of the one or more network services or the data traffic.
